(19) United States
(12) Patent Application Publication
(10) Pub. No.: US 2008/0073936 A1
(43) Pub. Date: Mar. 27, 2008

(54) Multi-Window Presentation System, Multi-Window File Editing System and Method Thereof

(76) Inventor: Jen-Her Jeng, Linnei Township (TW)

Correspondence Address: LAW OFFICES OF LAI AND ASSOCIATES, P.C., 5800 RANCHESTER STE 200, HOUSTON, TX, 77036, US

(21) Appl. No.: 11/534,132

(22) Filed: Sep. 21, 2006

(51) Int. Cl. B62D 35/00; G06F 3/048; B60R 27/00; B62D 37/02

(52) U.S. Cl. 296/180.1; 715/840

(57) ABSTRACT

A multi-window file editing system, and a multi-window presentation system and their methods are disclosed. The multi-window file editing system provides sessions with multiple windows to edit files among different program formats. The sessions, along with the windows and the files are combined to output a unique multi-window editing file or a multi-window presentation file. The multi-window editing file could be loaded into the multi-window file editing system for editing. The multi-window displaying file could be loaded into the multi-window presentation system for presenting.

### FIELD OF THE INVENTION

The present invention relates to a multi-window presentation system and a multi-window file editing system and their methods, and more particularly to a multi-window file editing system and its method that can display and edit files of different formats simultaneously.

### BACKGROUND OF THE INVENTION

At present, computers have become indispensable to our life, and the Windows operating system provides a visual operating interface to enhance the convenience of operating a computer. As computer applications become popular, various Windows application programs such as Word program for word processing, Excel program for designing spreadsheets, PowerPoint program for conducing presentations and MultiMedia Player for playing audio/video files are introduced. These Window application programs play very important roles for a salesperson's presentation, a teacher's slides for lectures or speeches, and a presenter's data, forms and illustrations.

As the presentation of data becomes increasingly complicated, a user may use more than one application program at a time. For instance, a professor may use PowerPoint for presentation while using Excel to show tables and data for assisting the description or play a documentary film to impress audiences in a speech. Although the Windows operating system can display the windows of several application programs simultaneously, a speaker has to control the position, size and operation focus of several windows, and thus it will affect the speaker's concentration on presenting the contents and lower the quality of the presentation. Further, the speaker usually needs to make a change to the content and sequence of presenting the data according to time, audience or current situation of the presentation. Since traditional presentation systems adopt linear sequence architecture and it is very common that speakers do not follow the originally planned sequence of their presentation, therefore speakers have to constantly change or switch different slides. As a result, the concentration of the speakers will be affected and the quality of their presentation will be lowered. The foregoing Windows application programs such as Word, PowerPoint or Excel can provide several windows to edit different contents simultaneously, but they can only edit files with different formats and save the content of a single window in a single file. Users have to maintain several files and thus such arrangement affect the operating efficiency.

In view of the shortcomings of the prior art, the inventor of the present invention based on years of experience in the area of Windows application programs provides a multi-window file editing system and its method and a multi-window presentation system and its method to overcome the foregoing shortcomings.

### SUMMARY OF THE INVENTION

Therefore, the primary objective of the presentation is to provide a multi-window presentation system, and a multi-window file editing system and their methods to improve the efficiency of editing files and conducting presentations.

To achieve the foregoing objective of the present invention, the invention provides a multi-window file editing system and its method that employ a multi-window template for generating at least one session with a plurality of windows, and each window could be used to load a file for displaying and editing the file. The session could contain a matrix of N×M windows, where N and M are integers greater than or equal to 1, and N×M is an integer greater than 1.

The present invention further provides a multi-window file editing system and its method, and the system could be combined with at least one session, a plurality of windows and a plurality of files, for outputting a multi-window file according to a user's need. The multi-window file could be a multi-window editing file loaded to the multi-window file editing system for file editing. The multi-window file also could be a multi-window presentation file loaded to a multi-window presentation system of the invention for displaying and conducting a presentation. Further, the multi-window file editing system can be used for playbacks and presentations.

The present invention further provides a multi-window file editing system and its method that can link different windows or different sessions. If the multi-window presentation system plays a multi-window presentation file, the operation focus is transferred from the currently operated window or session to a window or session with a link objective by a trigger signal.

Further, the present invention provides a multi-window file editing system and its method that can set the presentation parameters such as the position, size and sequence of the sessions and windows for the presentation of the sessions and the windows.

In view of the description above, the multi-window presentation system, and multi-window file editing system and their methods in accordance with the present invention have the following advantages:

(1) This multi-window file editing system and its method can provide several sessions, and each session has several windows, and thus users can load several files with different formats and the operating window for displaying and editing the files, so as to display files with different formats simultaneously in different operating windows and improve the convenience of editing files.

(2) This multi-window file editing system and its method can save the structure of several sessions and several windows into an editable multi-window file or a multi-window presentation file as needed, so as to improve the flexibility of utilizing the file.

(3) This multi-window file editing system and its method can provide users a way of classifying a plurality of files, assigning different sessions to the files according to the corresponding technical area and linking several sessions in series, in parallel, or in a tree or network structure, so as to improve the performance of a knowledge database.

(4) This multi-window presentation system and its method can display several files with different formats simultaneously, and the position, size and presentation sequence of the windows can be set in advance, so as to improve the efficiency of user's presentations.

To make it easier for our examiner to understand the objective of the invention, its structure, innovative features, and performance, we use a preferred embodiment together with the attached drawings for the detailed description of the invention.

### BRIEF DESCRIPTION OF THE DRAWINGS

FIG. 1 is a schematic diagram of a multi-window file editing system according to a preferred embodiment of the present invention;

FIG. 2A is a schematic diagram of a multi-window display of a preferred embodiment of the present invention;

FIG. 2B is a schematic diagram of a multi-window display of another preferred embodiment of the present invention;

FIG. 3 is a flow chart of a multi-window file editing method of a preferred embodiment of the present invention;

FIG. 4 is a schematic view of a multi-window presentation system according to a preferred embodiment of the present invention; and

FIG. 5 is a schematic diagram of a multi-window display of another preferred embodiment of the present invention.

### DETAILED DESCRIPTION OF THE PREFERRED EMBODIMENTS

In related figures of a preferred embodiment of a multi-window file editing system and its method, and a multi-window presentation system and its method in accordance with the present invention, the same numeral is used for labeling the same element in the embodiment to make it easier for our examiner to understand the present invention.

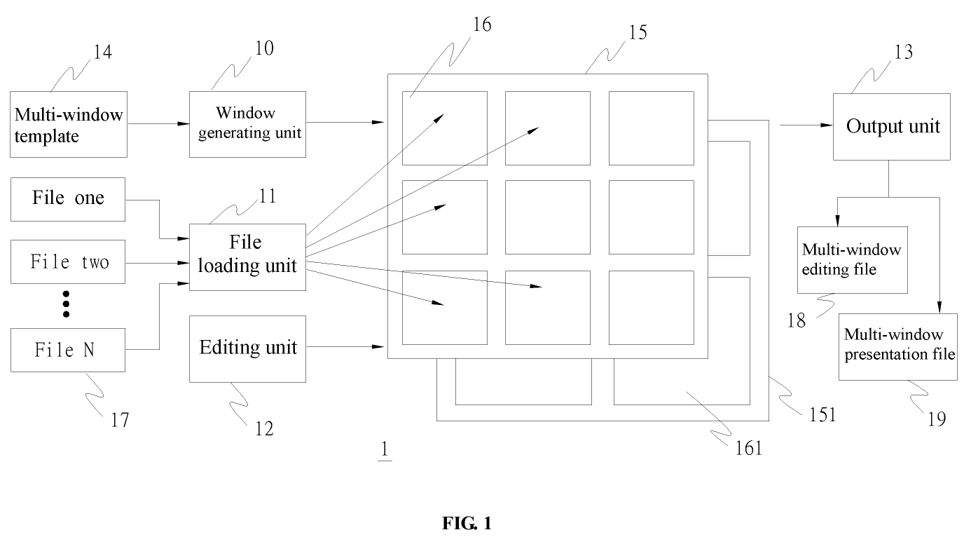

Referring to FIG. 1 for the schematic view of a preferred embodiment of a multi-window file editing system of the present invention, the multi-window file editing system 1 is provided for editing a plurality of files 17, and these systems comprise a window generating unit 10, a file loading unit 11, an editing unit 12 and an output unit 13. The window generating unit 10 generates at least one session 15 according to a multi-window template 14, and this session comprises a plurality of windows 16. The file loading unit 11 is provided for loading one of the files 17 to one of the windows 16. For example, a Word file can be loaded at the upper left corner of the window, and a PowerPoint file can be loaded at the upper right corner of the window. The multi-window template 14 is a commonly used window allocated data pre-designed for the session.

The editing unit 12 provides an operating interface for editing the content of each file 17 through these windows 16. The output unit 13 integrates the sessions 15, the windows 16 and the files 17 to generate a multi-window file as needed. The multi-window file could be a multi-window editing file 18 provided for users to load the file to the multi-window file editing system 1 at a later time for editing the file again. Further, the multi-window file also could be a multi-window presentation file 19 provided for users to load the file to the multi-window presentation system for conducting presentations. Besides the multi-window file editing function, the multi-window file editing system 1 also provides a presentation function for the edited file, so that users can immediately check the effect of presenting the file.

A plurality of files could be created with different file formats including a presentation file format (such as PowerPoint file format), a document file format (such as Word file format or Excel file format), a graphic file format (such as Bmp, Gif or Jpg file format), an audio/video file format (such as Wma, Wmv, Mpeg or Avi file format) or a browser file format (such as html file format), etc. The file loading unit 11 drags a file into a window by a mouse or inputs an instruction for opening and loading a file.

Further, users can produce a plurality of sessions such as a session 15 and a session 151 as needed by different multi-window templates 14, and each session includes a matrix of N×M windows, and N and M are integers greater than or equal to 1, and N×M is an integer greater than 1. For example, the session 15 having a 3×3 matrix comprised of nine windows 16, the session 151 having a 2×2 matrix comprised of four windows 161, or the multi-window template 51 as shown in FIG. 5 having a 2×2 window matrix at the upper left corner of the multi-window template 51 fall within the scope of claims of the present invention.

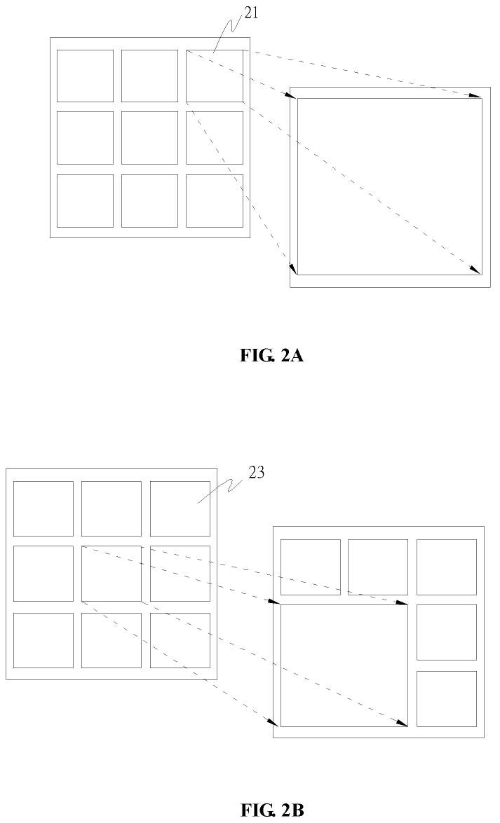

Each window can load different files. The multi-window file editing system 1 further comprises a setting unit for setting related parameters such as the position, size and sequence of the sessions and windows for the presentation of the sessions and the windows as shown in FIG. 2A. If the window 21 receives a trigger signal, the display screen will be enlarged to cover other windows, such that the content of the window 21 can be displayed more clearly. In FIG. 2B, if the window 23 receives a trigger signal, the display screen will be enlarged to cover other parts of the window, so as to improve the display of the content of the window 23 and maintain the top and the right side of the window for users to compare and view these two sections. By setting the window presentation parameters, users can optimize the settings for the display of several files. Further, users can set a plurality of window presentation parameters. For example, if the window receives a trigger signal for the first time, the display screen may be enlarged to cover other parts of the window (as shown in FIG. 2B), and if the window receives a trigger signal again, then the display screen may be enlarged to a full screen (as shown in FIG. 2 A), and if the window receives a trigger signal again, the original position and size of the window may be recovered. Users can set the window presentation parameters according to the required presentation content to improve the efficiency of conducting presentations.

The multi-window file editing system 1 further comprises a link unit for setting a link of any combination of different windows or different sessions. The link receives a trigger signal for transferring an operation focus from the currently operated window or session to a window or session with linked objectives. The link between different windows or different sessions comprises a serial link, a parallel link, a tree-structured link or a network link. The foregoing trigger signal could be a signal inputted from a press key at a specific area of a mouse or a link instruction inputted from a keyboard.

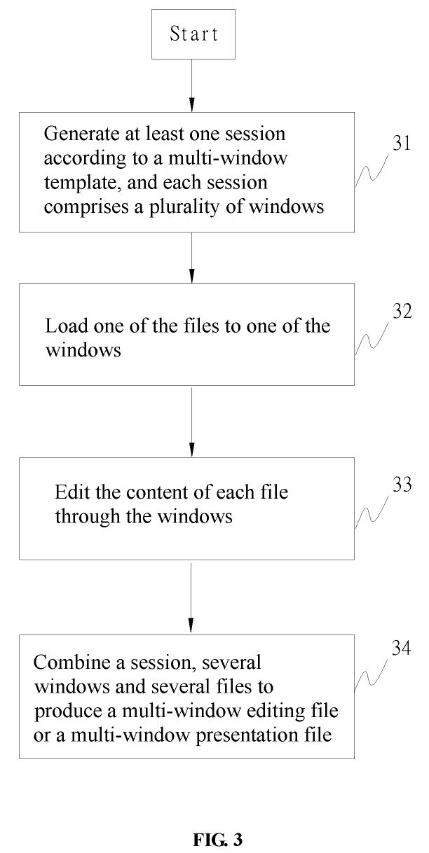

Referring FIG. 3 for the flow chart of a method of editing a multi-window file according to a preferred embodiment of the present invention, the method edits a multi-window file as shown in FIG. 1 by a procedure comprising the steps of:

Step 31: using the window generating unit 10 to generate at least one session according to a multi-window template, and each session comprises a plurality of windows;

Step 32: using a file loading unit 11 to load one of the files to one of the windows;

Step 33: using an operating interface of an editing unit 12 to edit the content of each file through the windows; and

Step 34: using an output unit 13 to combine a session, several windows and several files to produce a multi-window file.

The method of editing a multi-window file further comprises the step of setting a parameter related to the presentation of the sessions and windows, and this parameter comprises the position, size and sequence of the presentation of the sessions and the windows. The method of editing a multi-window file further comprises the step of setting a link for any combination of different windows or different sessions. The multi-window file could be a multi-window editing file, so that users can load the file to the multi-window file editing system 1 at a later time for editing the file again. The multi-window file also could be a multi-window presentation file, so that users can load the file to the multi-window presentation system at other time for the presentation.

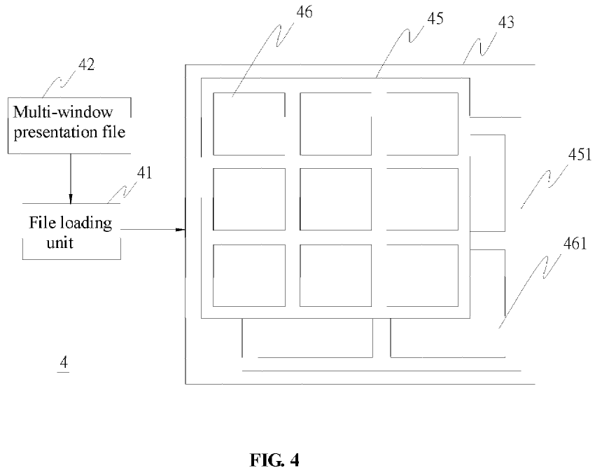

Referring to FIG. 4 for the block diagram of a multi-window presentation system of the present invention, the multi-window presentation system 4 comprises a file loading unit 41 and a playing unit 43. The file loading unit 41 is provided for loading a multi-window presentation file 42, and the playing unit 43 is provided for displaying at least one session 45, a plurality of windows 46 and a plurality of files contained in the multi-window presentation file 42, and presenting the files according to the presentation parameters of the multi-window presentation file 42. If the multi-window presentation file 42 comprises a plurality of sessions, then the playing unit 43 can simultaneously display several sessions and their windows such as session 45, session 451, window 46 and window 461 as shown in the figure. The foregoing presentation parameter comprises the position, size and sequence of presenting a session and a window. The playing unit 43 can transfer an operation focus from the currently presented window or session to a set window or session with linked objectives according to a trigger signal.

While the invention has been described by way of example and in terms of a preferred embodiment, it is to be understood that the invention is not limited thereto. To the contrary, it is intended to cover various modifications and similar arrangements and procedures, and the scope of the appended claims therefore should be accorded the broadest interpretation so as to encompass all such modifications and similar arrangements and procedures.

What is claimed is:

1. A multi-window file editing system, that edits a plurality of files with different program formats, comprising:
a window generating unit, for generating at least one session according to a multi-window template, and said session comprising a plurality of windows;
a file loading unit, for loading one of said files to one of said windows;
an editing unit, for providing an operating interface and editing the content of said each file through said windows; and
an output unit, coupled to said sessions, said windows and said files, for generating a multi-window file.

2. The multi-window file editing system of claim 1, wherein said program formats comprise a presentation file format, a document file format, a graphic file format, an audio/video file format or a browser file format.

3. The multi-window file editing system of claim 1, wherein said session comprises a matrix of N×M windows, and N and M are integers greater than or equal to 1, and N×M is an integer greater than 1.

4. The multi-window file editing system of claim 1, further comprising a setting unit for setting parameters related to the presentation of said sessions and said windows.

5. The multi-window file editing system of claim 4, wherein said parameter comprises at least one position, at least one size and a sequence for presenting said sessions and said windows.

6. The multi-window file editing system of claim 1, further comprising a link unit for setting a link of any combination of different windows and different sessions.

7. The multi-window file editing system of claim 6, wherein said link transfers an operation focus from the currently operated window or session to a target linked window or session according to a trigger signal.

8. The multi-window file editing system of claim 6, wherein said link relation between different windows or different sessions comprises a serial link relation, a parallel link relation, a tree-structured link relation or a network link relation.

9. The multi-window file editing system of claim 1, wherein said multi-window file is a multi-window editing file or a multi-window presentation file.

10. A method of editing a multi-window file, that edits a plurality of files with different program formats, comprising the steps of:
generating at least one session according to a multi-window template, and said session comprising a plurality of windows;
loading one of said files to one of said windows;
using an operating interface to edit the content of said each file through said windows; and
combining said sessions, said windows and said files to generate a multi-window file.

11. The method for editing a multi-window file of claim 10, wherein said program formats comprise a presentation file format, a document file format, a graphic file format, an audio/video file format or a browser file format.

12. The method for editing a multi-window file of claim 10, wherein said session comprises a matrix of N×M windows, and N and M are integers greater than or equal to 1, and N×M is an integer greater than 1.

13. The method for editing a multi-window file of claim 10, further comprising a presentation parameter for setting the presentation of said sessions and said windows.

14. The method for editing a multi-window file of claim 13, wherein said presentation parameter comprises at least one position, at least one size and a sequence of presenting said sessions and said windows.

15. The method for editing a multi-window file of claim 10, further comprising a link of any combination of different windows or different sessions.

16. The method for editing a multi-window file of claim 15, wherein said link transfers an operation focus from the currently operated window or session to a target linked window or session according to a trigger signal.

17. The method for editing a multi-window file of claim 15, wherein said link relation between different windows or different sessions comprises a serial link relation, a parallel link relation, a tree-structured link relation or a network link relation.

18. The method for editing a multi-window file of claim 10, wherein said multi-window file is a multi-window editing file or a multi-window presentation file.

19. A multi-window presentation system, comprising:
a loading unit, for loading a multi-window presentation file; and
a playing unit, for displaying at least one session, a plurality of windows and a plurality of files contained in said multi-window presentation file, and presenting said files according to said presentation parameter of said multi-window presentation file.

20. The multi-window presentation system of claim 19, wherein said presentation parameter comprises at least one position, at least one size and a sequence for presenting said sessions and said windows.

21. The multi-window presentation system of claim 19, wherein said playing unit transfers an operation focus from the currently operated window or session to a target linked window or session according to a trigger signal.
